(19) United States
(12) Patent Application Publication
(10) Pub. No.: US 2008/0319357 A1
(43) Pub. Date: Dec. 25, 2008

(54) PINCH-RESISTANT MAGNETIC MASSAGE WANDS

(76) Inventor: Lawrence Ray Hey, Newcastle, OK (US)

Correspondence Address: MARTIN A. WEEKS, 1909 ALADDIN, NORMAN, OK, 73072, US

(21) Appl. No.: 11/766,630

(22) Filed: Jun. 21, 2007

(51) Int. Cl. A61H 1/00

(52) U.S. Cl. 601/15; 601/119

(57) ABSTRACT

The invention is for a pair of pinch-resistant magnetic massage wands that have handles with a magnet disposed in a central bore of each handle. The magnet is oriented along a centerline of the handle so that a first end of the magnet is contained within the handle and a second end of the magnet is protruding from a top ridge of the handle. Each end of the magnet corresponds to a pole of the magnet. The magnets are oriented in the handles so that the same poles of each magnet protrude from the handle top ridge. When the massage wands are brought in close proximity of one another, the magnets exert opposing forces on one another to prevent a massage therapist from inadvertently pinching a patient with the massage wands.

### CROSS-REFERENCE TO RELATED APPLICATIONS

Not applicable

### BACKGROUND

The use of devices to massage and apply pressure to parts of the human body have been known for centuries as a method for providing relaxation, pleasure and medical therapy for humans. In more recent times, veterinarians and animal owners have recognized that these same devices could also be used with animals to produce healthier and more content animals. For example, race horses are in danger of injury if they are not properly “cooled down” and their muscles relaxed after a race. Similarly, it is important for “show” animals to display a content disposition during dog or livestock shows.

Massage therapists have also recognized that subjecting parts of the human body to electromagnetic fields can provide a tingling sensation that many of their patients find to be relaxing and pleasurable. In order to work more efficiently, many massage therapists prefer to have devices in each hand with which to massage their patients. However, this can be a problem when the devices have magnets.

Massage devices that have magnets within the device can sometimes pinch their patients when the devices are used in pairs and the devices have magnetic elements that attract to one another. This can be very uncomfortable or even painful for a human. When the patient is an animal such as a horse, the animal may be startled and create a danger to the massage therapist or anyone else nearby.

It is to solving these and other problems that the present invention is directed.

### BRIEF DESCRIPTION OF THE DRAWINGS

FIG. 1 shows a side elevation view of a massage wand constructed in accordance with a preferred embodiment of the present invention.

FIG. 2 shows a cross sectional view of the massage wand shown in FIG. 1.

FIG. 3 shows a top view of the massage wand shown in FIG. 1.

FIG. 4 shows a top view of an alternative embodiment of a massage wand constructed in accordance with a preferred embodiment of the present invention.

FIG. 5 shows a side elevation view of a pair of massage wands constructed in accordance with a preferred embodiment of the present invention.

### SUMMARY OF THE INVENTION

The invention is for a pair of massage wands that have generally cylindrical handles with a magnet disposed in a central bore of each handle. The magnet is oriented along a centerline of the handle so that a first end of the magnet is contained within the handle and a second end of the magnet is protruding from a top ridge of the handle. Each end of the magnet corresponds to a pole of the magnet. The magnets are oriented in the handles so that the same poles of each magnet protrude from the handle top ridge. When the massage wands are brought in close proximity of one another, the magnets exert opposing forces on one another to prevent the massage therapist from inadvertently pinching a patient with the massage wands.

### DESCRIPTION

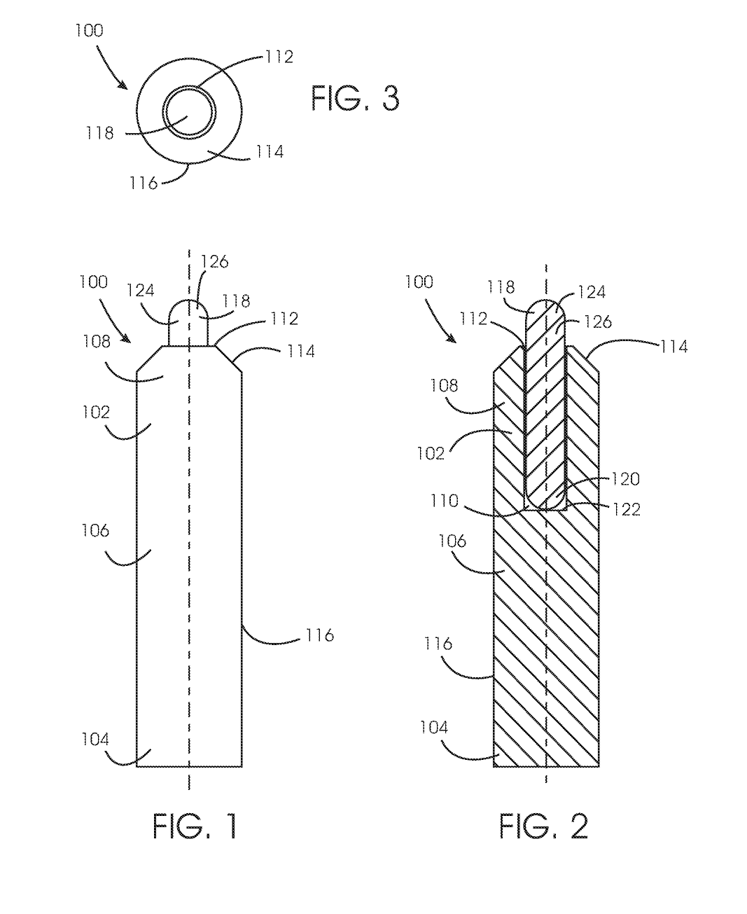

FIGS. 1 and 2 show a side view and a cross-sectional view, respectively, of the massage wand 100. The massage wand 100 has a generally cylindrical handle 102 with lower end 104, a mid-portion 106, and an upper end 108. A central bore 110 is defined in the handle upper portion 106 in a center of a top ridge 112 of the handle 102. The handle 102 also has a beveled surface 114 that tapers from the wider outside surface 116 of the handle to the diameter of the narrower top ridge 112.

A magnet 118 is disposed in the central bore 110 0s a first end 120 is located near the central bore bottom 122 and a second end 124 protrudes above the top ridge 112. Each magnet end 120, 124 is associated with either a south pole or a north pole of the magnet 118. A part of the magnet 118 that protrudes above the handle top ridge 112 is termed a probe 126. Each probe 126 of the pair of magnets 118 has the same polarity so that the probes 126 exert opposing forces on one another when a massage therapist brings the probes 126 sufficiently close to one another. The opposing forces of the massage wands may 100 be exerted by either south poles of the magnets or the north poles of the magnets 118.

The magnet 118 is permanently secured inside the central bore 110 by a press fit in one embodiment. This is achieved by forming the handle from a non-rigid material, such as plastic, rubber, wood, or a non-ferrous metal and forming the central bore 110 with a slightly smaller diameter than the diameter of the magnet 118. In another embodiment, the magnet 118 is removably secured inside the central bore 110 by forming the central bore 110 to be approximately the same diameter as the diameter as the magnet 118. For this embodiment, the magnet 118 may be interchanged with another magnet 118 for use with different patients. In yet another embodiment, the magnet 118 is permanently attached inside the central bore 110 by using an adhesive, such as hot glue or an epoxy.

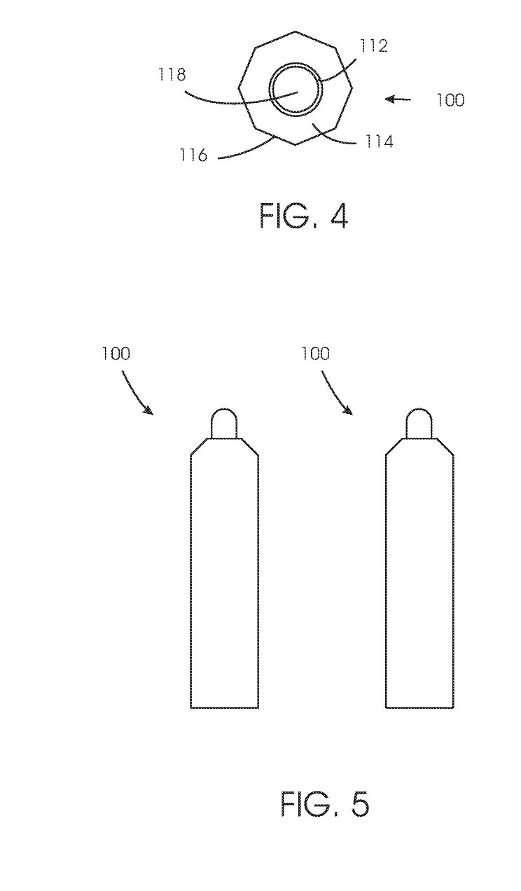

FIG. 4 shows a top view for another alternative embodiment of a massage wand 100. For the embodiment shown in FIG. 5, the handle outside surface 116 has an octagonal shape. Forming the handle outside in an octagonal or other polygonal shape helps to prevent the massage wands 100 from rolling if they are positioned with the handle outside surface 116 in a horizontal position on a horizontal surface, such as a table.

FIG. 5 shows a pair of the massage wands 100 shown in FIG. 1. The massage wands 100 are typically used in pairs to massage a patient.

The handle 102 may be formed from any suitable material including plastic, rubber, wood, or non-ferrous metal. The material should not be magnetizable material, such as steel or iron, because it is not generally desirable to have the handle 102 be magnetized. The magnet 118 is formed from any material that is capable of being magnetized, such as steel or iron.

In one embodiment, the massage wands 100 are constructed by providing a piece of material from which the handles 102 are made, turning the piece of material on a lathe, using a chisel to define the properly dimensioned outside surface 116 and the beveled surface 114, using a drill press to form the central bore 110, and inserting a round magnet 118 inside the central bore 110.

In another embodiment, the handle 102 is formed by a plastic injection mold. In this embodiment, the maker provides a plastic injection mold with the handle 102 geometry defined in the mold. Next, molten plastic is injected into the mold. Next, the molded handle 102 is removed from the mold. Finally, the plastic is allowed to cool to form the handle 102. The magnets 118 are then inserted into the central bore 110 while the plastic is still hot so that the plastic cools and shrinks to secure the magnets 118 inside the central bore 110.

In one embodiment, the handle outside surface 116 has a diameter of 2.5 cm (1.0 inch) and the magnet 118 has a diameter of 12.5 cm (0.5 inch). The spherically shaped end of the magnet has a radius of curvature of 6.25 cm (0.25 inch). However, the dimensions of particular embodiments may be varied to suit the size of the hands of the massage therapist and to suit the patient's comfort.

The electromagnetic field strength of the magnets 118 should be selected so that the magnets 118 induce a slight tingling in the tissue of a patient. Furthermore, the field strength of the magnets should not be so strong that the magnets 118 cannot be comfortably placed with 50 mm (2 inches) of one another. However, the field strength should also be such that the magnets 118 may not be forced together by moderate hand forces.

In use, the massage therapist positions the massage wands 100 on the skin of an animal or person (patient) and applies pressure to the massage wands 100 in the direction of the patient, while rotating the massage wands in a generally circular motion. The surface 114 is beveled so that the probe 126 may be pressed more deeply into the flesh of the patient than the probe 126 could be pressed if the surface 114 were not beveled. This is especially important in the massaging of large animals, such as horses, that have deeper muscle tissues.

In one embodiment, one of the massage wands is rotated in a clockwise direction while the other massage wand is rotated in a counter-clockwise direction. When the massage wands come close to one another in their respective rotations, each massage wand exerts an opposing force on the other massage wand.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A pair of pinch-resistant magnetic massage wands for massaging a patient, each massage wand comprising:
(a) a generally cylindrical handle with a central bore defined in the handle;
(b) a magnet disposed in the central bore, wherein each magnet has a first end and a second end, wherein each of the magnet first end and second end comprise a north or south pole of the magnet, wherein the first end of the magnet is located at a bottom of the central bore, wherein the second end of the magnet protrudes above a top ridge of the handle and comprises a probe, wherein the probe has the same polarity in each massage wand so that each probe exerts a repulsive force on the other, and wherein each probe is pushed against a skin of the patient and rotated to massage the patient.

2. The pair of massage wands of claim 1 wherein an outside surface of the handle has a circular cross section.

3. The pair of massage wands of claim 1 wherein an outside surface of the handle has a non-circular cross section.

4. The pair of massage wands of claim 1 wherein an outside surface of the handle has a polygonal cross section to prevent each massage wand from rolling on a horizontal surface.

5. The pair of massage wands of claim 1 wherein each magnet is permanently secured inside one of the central bores by a press fit.

6. The pair of massage wands of claim 1 wherein each magnet is permanently secured inside one of the central bores by an adhesive.

7. The pair of massage wands of claim 1 wherein each magnet is removably secured inside the central bore.

8. The pair of massage wands of claim 1 wherein the handle is made of plastic.

9. The pair of massage wands of claim 1 wherein the handle is made of rubber.

10. The pair of massage wands of claim 1 wherein the magnet is made of a magnetizable material.

11. The pair of massage wands of claim 1 wherein the magnet has a circular cross section.

12. The pair of massage wands of claim 1 wherein the handle has a beveled surface that tapers from a wider outside surface to a diameter of the narrower top ridge to permit the probes to be pressed more deeply into flesh of the patient.

13. A method of massaging a patient with the massage wands of claim 1 wherein each massage wand is pressed against flesh of the patient and rotated.

14. The method of claim 13 wherein one massage wand is rotated in a clockwise direction while the other massage wand is rotated in a counter-clockwise direction.

15. A method for making a pinch-resistant massage wand, comprising the steps:
(A) making a handle with a central bore; and
(B) inserting a magnet into the central bore.

16. The method of claim 15 wherein the step (A) comprises:
(A1) providing a piece of material from which the handle is made;
(A2) turning the piece of material on a lathe and using a chisel to define the outside surface and the beveled surface of the handle; and
(A3) using a drill press to define the central bore of the handle.

17. The method of claim 15 wherein the step (A) comprises:
(A1) providing a plastic injection mold with the handle geometry defined in the mold;
(A2) injecting molten plastic into the mold;
(A3) removing the molded handle from the mold; and
(A4) allowing the plastic to cool to form the handle.

18. The method of claim 17 wherein the magnets are inserted into the central bore while the plastic is still hot so that the plastic cools and secures the magnets inside the central bore.

19. A pair of massage wands made by the method of claim 15.
